(19) United States
(12) Patent Application Publication
(10) Pub. No.: US 2018/0025663 A1
(43) Pub. Date: Jan. 25, 2018

(54) Method of Dementia Care

(71) Applicant: Judy A. Cornish, Moscow, ID (US)

(72) Inventor: Judy A. Cornish, Moscow, ID (US)

(21) Appl. No.: 15/218,019

(22) Filed: Jul. 23, 2016

(51) Int. Cl. G09B 19/00

(52) U.S. Cl. CPC G09B 19/00

(57) ABSTRACT

A method for caring persons suffering from dementia. The disclosed method of care lowers caregiver stress and helps the patient stay home longer. The disclosed method is a set of seven steps comprising tools caregivers can use to help someone who has dementia develop and maintain a sense of security and wellbeing, despite the progression of dementia. The seven steps include (1) managing mood, (2) making it safe to ask, (3) making it safe to trust, (4) creating social success, (5) creating a sense of control, (6) creating a sense of value, and (7) creating a sense of a safe future. The disclosed method provides simple steps that can attain immediate positive results.

### CLAIM OF PRIORITY TO PROVISIONAL APPLICATION (35 U.S.C. §119(e))

This application claims priority under 35 U.S.C. §119(e) from provisional patent Application No. 62/199,161, filed Jul. 30, 2015. The 62/199,161 Application is incorporated herein by reference.

### FIELD OF THE INVENTION

The present invention relates to the care of persons suffering from dementia and the application of that care by care givers.

Dementia is a general term for a number of brain disorders, characterized by an ongoing deterioration of memory and thinking ability. One form of dementia is Alzheimer's disease, a progressive degeneration of brain function, most commonly suffered by persons over the age of sixty-five, although it is not considered a normal part of ageing. According to the World Health Organization, almost fifty million people worldwide have dementia, of which the majority are attributed to Alzheimer's disease. In the United States, the Alzheimer's Association estimates that over five million people suffer from Alzheimer's disease, including one in eight people over age sixty-five and nearly fifty percent of people over age eighty-five. And, the number of people suffering from dementia is expected to increase significantly, owing to increasing life expectancies.

Loss of memory and cognitive function in those suffering from dementia is severe enough to interfere with daily life. While the Americans with Disabilities Act (“ADA”) looks at the extent to which a disease affects “Activities of Daily Living”, or “ADLs”, such as bathing, dressing and eating, dementia interferes with “instrumental Activities of Daily Living” (“iADLs”). Examples of iADLs include managing money, taking medications, using appliances, shopping, caring for pets, using the phone, or alerting someone in the case of an emergency. Dementia care involves managing iADLs by assisting persons with these activities. The person suffering from dementia will often be distraught at having another person assist with or take over such activities, leading to stress and insecurity. In providing such assistance, it is important to meet the emotional needs for security and wellbeing.

Care for a person suffering from dementia is highly personalized and requires the direct attention of a Dementia Care Giver (“DCG”). Often, DCGs are untrained in the care of persons suffering from dementia. Not infrequently, DCGs will be inclined to provide care by taking over iADLs and treating the dementia sufferer as incapacitated. This type of care can increase the stress and insecurity of the dementia sufferer. Owing to the challenges posed by a person suffering from dementia and the attention required of DCGs, it is difficult to train DCGs in methods that are successful. Moreover, the delivery of such care can be very demanding and impose substantial stress on the DCG.

### OBJECTS OF THE INVENTION

For these and other reasons there is a need for the present invention.

What is needed is a method of dementia care that is effective in delivering such care. Also needed is a method that provides DCGs tools to provide care without unnecessary stress and anxiety.

One of the objects of the present invention is to provide a method of dementia care that gives joy, peace, and respite to the person suffering from dementia. Another object is to provide a method that employs tools for dementia care that can be used by DCGs to care for dementia sufferers. An additional object of the present invention is to reduces stress and anxiety in DCGs by providing a method of dementia care that can be easily applied.

### SUMMARY OF THE INVENTION

The present invention employs a set of tools for a DCG to use to manage the care of a dementia sufferer. The tools are sequenced for both the DCG and the dementia sufferer (1) to manage mood, (2) to create an environment in which confusion experienced by the dementia sufferer is reduced and (3) trust in the DCG's care is increased, (4) to increase the dementia sufferer's social success, (5) to increase the dementia sufferer's feeling of control, (6) human value, and (7) security in the future. Step (1) discloses tools for the DCG to manage the mood of the dementia sufferer. Steps (2) through (3) fall within the broader category of fostering security and the disclosed invention provides a DCG with tools to follow to enhance the dementia sufferer's sense of security. Steps (4) through (6) fall within the broader category of fostering positive sensations and the disclosed invention provides the DCG with tools to help establish and environment that fosters such sensations for the dementia sufferer. Step (7) is a tool to foster wellbeing in the dementia sufferer.

Accordingly, the present invention is a series of steps that disclose the following tools for a DCG to use in providing care to a dementia sufferer.

Mood Management:

1. Managing Mood:
a. DCG's Mood
   i. Get in the moment
   ii. Empathize
   iii. See the person, not the task
   iv. Can I pretend to be in a good mood?
   v. Choose the better goal
      1. Embrace dementia time
b. Re-Direct Dementia Sufferer's Mood:
   i. Use positive emotional tags
      1. Intonation and emphasis
      2. Gestures and posture
      3. Timely eye contact
      4. Meaningful touch
   ii. Where is the mood coming from?
      1. When the mood is the result of something specific
         a. Use chatter
      2. When the mood is the result of general unease
         a. Introvert or extrovert?
         b. Use social stimulation
         c. Use sensory stimulation
   iii. Accept Altered Versions of Reality
      1. What is reality anyway?
      2. Supporting altered realities
      3. Is it lying?
   iv. Mood, the gift that keeps on giving.

Fostering Security:

2. Security in Confusion—Making it Safe to Ask:
a. DCG Asks Self: Why Do We Need to Know?
   i. How does it feel to need to constantly ask?
   ii. How does it feel to be constantly asked?
b. Teaching Security in Confusion
c. Use Chatter
   i. Offer information or reassurance
      1. Recognize when information is needed
      2. Recognize when reassurance is needed
d. What the Dementia Sufferer Sees is What They Hear:
   i. Use intonation
   ii. Be aware of expressions and gestures
   iii. Heart-to-heart or buddy-to-buddy?
   iv. Reassure (Get the Morphine Button Effect)

3. Security in Care—Making it Safe to Trust:
a. DCG Sets the Stage
   i. Be punctual
   ii. Provide continuity in caregivers
   iii. Respect dementia time
b. DCG Teaches Security in Care
c. Making it Safe to be Confused
   i. Avoiding testing memory
d. Making it Safe to be Unable to Do a Task
   i. Verbalizing each step
   ii. Modeling doing the task
e. Making it Safe to be Unable to Recall
   i. Lost memories
      1. Working with lost memories
      2. Validate the emotions experienced—right or wrong
   ii. Inaccurate memories
   iii. False memories
f. Empathizing with Forgetfulness

Fostering Positive Sensations:

4. Fostering Social Success:
a. Creating Wellbeing with Social Success
b. Foreseeing Awkward Moments
   i. When an old friend approaches to chat
   ii. When transacting business
   iii. When beginning or ending activities or events
   iv. Lost attention span during activities
   v. Shaping the experience is crucial
c. Managing Conversations
   i. Anchoring the conversation in the present
      1. Focusing on what our senses provide
      2. Becoming a spectator
   ii. Encouraging favorite anecdotes
   iii. Introducing forgotten memories
d. Wellbeing Through Social Success
e. Enhancing DCG's Own Wellbeing

5. Fostering a Sense of Control:
a. Creating a Sense of Control
b. Enabling Choice
   i. Creating either/or choices
   ii. Making options visible
   iii. Using cueing
c. Using Catchphrases
d. Letting Dementia Sufferer To Own the Moment
   i. DCG recognizes the lesser of two evils
   ii. Am I being manipulative?
   iii. DCG: “Silly me—I forgot again”
   iv. Making them the instructor
e. Hiding the End Goal
f. Allowing Autonomy
g. Enhancing DCG's Own Wellbeing

6. Fostering a Sense of Value:
a. Giving the Sense of Being Valued
b. Accepting What The Dementia Sufferer Says
   i. Incorrect statements
   ii. Listen, really listen
   iii. Language becomes more flexible
c. Balancing Safety and Selfhood
   i. Recognizing long-held beliefs
   ii. Respecting longstanding habits
   iii. Supporting earlier personality traits
d. Blaming a Third Party
e. Giving The Dementia Sufferer a Chance to be Gracious
   i. The giving of gifts
f. And When We Don't Want To?

Fostering Wellbeing:

7. Securing The Future:
a. Applying Tools
b. Identifying What Symbolizes Security
c. Being Present as Much as Needed:
   i. Allowing independence
   ii. Uncertainty
   iii. Following the leader
   iv. Clinginess
   v. Overnight care
   vi. Fulltime care
   vii. Verbalize Love and Caring.

### BRIEF DESCRIPTION OF THE DRAWING

FIG. 1 is an graphical outline of the method of the present invention.

### DETAILED DESCRIPTION OF THE PREFERRED EMBODIMENT

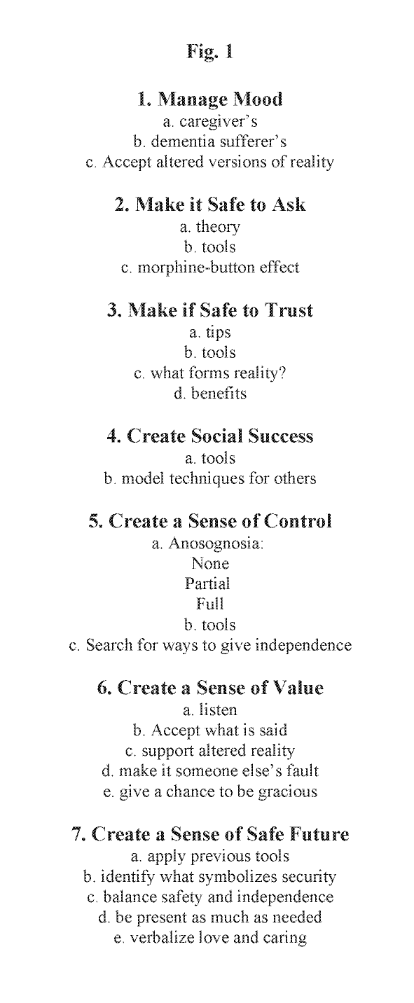

Referring to FIG. 1, seven numbered steps are outlined in sequence for managing mood, fostering security, fostering social success, fostering a sense of control, and promoting a feeling of wellbeing in a person suffering from dementia.

Three foundational tools create a sense of security leading to a sense of wellbeing:

1. Mood management;

2. Making it safe to ask questions; and

3. Making it safe to trust others.

Fostering a sense of wellbeing involves:

4. Feeling socially successful;

5. Having a sense of control;

6. Feeling valued; and

7. Knowing the future is secure.

Step 1: Mood Management

Healthy people manage mood continuously by reasoning ourselves out of negative moods, remembering positives, planning a treats and rewards, and distinguishing dreams and reality. People with dementia can't do these things, they can't remember, lose attention, fail at tasks, can't plan, get scared, get confused, get frustrated, and worry.

a. The Dementia Care Giver's Mood

To manage mood, the first step is for the DCG to manage his or her own mood before trying to manage the mood of the dementia sufferer. In setting one's own mood, the DCG can use the following tools:

1. Get in the moment:
a. Put aside your worries
b. Put aside what's happened already
c. Focus on what's happening now
d. Focus on what might happen
e. Avoid self criticism—Give yourself a break!

2. Empathize with the dementia sufferer:
a. Remember that dementia is an illness
b. Imagine having no memory
c. Imagine living in confusion
d. Remember the dementia sufferer is not at fault

3. Focus on the dementia sufferer, not task:
a. Have a pleasant interaction
b. Make the immediate present a good moment
c. Enjoy respite from the worries with the dementia sufferer.

Mood can prevent accomplishing the task; the DCG's mood will transfer to the dementia sufferer. Thus, if the DCG is rushed, preoccupied, or worried, then the dementia sufferer will feel likewise. But, if the DCGs mood is relaxed, in the moment, and accepting, this will transfer to the dementia sufferer.

Similarly, if a deadline must be met, the caregiver should:
Present one step at a time
Make the deadline the DCG's idea.

b. The Dementia Sufferer's Mood

Once the DCG has set his/her own mood it is possible to change the mood of the dementia sufferer. The DCG should recall that having dementia means being unable to reason oneself out of a negative mood, to remember something positive, to plan a treat for later, or to distinguish dreams from reality.

But, the DCG can manage a dementia sufferer's mood by:
Distracting the dementia sufferer with appropriate stimulus
Using planning to provide positive activities
Bringing up only positive emotions
Working with the dementia sufferer's dreamed events.

The DCG can also manage mood by recognizing that a mood change is needed owing to an adverse event or because dementia sufferer is distressed over being unable to remember or some other manifestation of dementia. When and adverse event triggers a need to manage mood, the DCG can:
Verbalize: provide brain chat to reduce stress
Model doing the task causing the distress (i.e., step by step)
Use nonverbal communication

Verbalizing “brain chat” is a method of engaging a dementia sufferer in a conversation about problem solving steps. Normally, a person approaches a problem by sorting, organizing, differentiating, sequencing steps toward a solution, and reaching a conclusion. But, a dementia sufferer may get stuck on a problem, try starting again, become frustrated, and then become scared.

The DCG can use verbalization and brain chatter to reduce the stress experienced by a dementia sufferer and follow up by modeling behavior for solving a problem or performing a task. For most people, seeing or hearing stimulates recall of sequences for performing a task. Thus, to help a dementia sufferer manage a problem or event, the DCG can use words and actions to describe the sequences for solving the problem or responding to the event. This may held the dementia sufferer to recall the process and sequences. The use of nonverbal communication is especially effective. The DCG will use intonation, expression, gesture, body language, and posture to help the dementia sufferer through a problem or event.

It is also important for the DCG to recognize whether the individual dementia sufferer is an introvert or extrovert. The DCG should determine whether the dementia sufferer is an introvert: enjoys his or her own company, prefers one-on one interaction, is quiet. Or, whether the dementia sufferer is an extrovert: enjoys others' company, likes groups and crowds, or is gregarious. Depending on whether the dementia sufferer is an introvert or extrovert, the DCG will choose stimulation that is more sensory, for introverts, or more social, for extroverts.

Examples of sensory stimuli include colors, scents, tastes, sounds, or textures. Examples of social stimulation include conversation, movies, group activities, being involved, or interacting with others.

c. Focus on the Dementia Sufferer, not the Task

Conventional care of dementia sufferers follows the pattern of general medical care and focuses on the disease and tasks prescribed for treating it. By focusing on the task, a care giver conveys an interest in the task, rather than in the person. It also conveys a preference for the future, when the task is completed, rather than the present. With dementia sufferers, this approach leads to conflict, because the dementia sufferer cannot hold onto the task. This approach does not work for dementia sufferers. The DCG must focus on the person, not the task. To accomplish this step, the DCG should focus on the immediate present, convey to the dementia sufferer that the DCG cares about him or her, and cooperate with the dementia sufferer, even though such focus and cooperation will have no impact on completion of a task.

In caring for a dementia sufferer, the DCG will accept altered reality with kindness. Memory creates reality, but the dementia sufferer lacks the ability to rely on memories, some of which may be inaccurate, absent, and false.

Step 2: Making it Safe to Ask

It is common for dementia sufferers to ask the same question repeatedly. This can be stressful to the DCG and the dementia sufferer. The DCG who is asked the same question over and over again will naturally feel as if he or she is being made fun of, trapped, and irritated. Upon being told that he or she has asked the same question recently, the dementia sufferer will feel dumb, like a nuisance and burden, unsafe. and frustrated. Therefore, the second step in the disclosed method of dementia care is creating an environment in which the dementia sufferer feels safe to ask questions.

a. Understanding the Theory

The theory is that dementia destroys the analytical brain, but the intuitive brain functions remain. Rational thinking implies linearity and the ability to recall facts, do math, make decisions, use judgment, maintain focus on facts, absorb details, deconstruct, deliberate, and explain. The dementia sufferer is usually unable to perform one or more of these cognitive processes. By contrast, intuitive thinking is considered more basic and involves reading feelings, not facts, interpreting experience, not knowledge, and responding to impressions, not data. Intuitive thinking may be less focused than rational thinking, but can be dynamic, spontaneous, and less dependent on details. For the dementia sufferer, these processes are often intact and provide intuitive, unconscious, instantaneous, and experience-based mechanisms to respond to situations.

b. Tools

The DCG should understand the theory before employing the disclosed tools to take care of the analytical for the dementia sufferer. Thus, the DCG can provide the facts and expect the dementia sufferer to be intuitive only.

The DCG should be prepared to respond the need of the dementia to ask questions, often repeatedly. The dementia sufferer asks questions because he or she needs information (facts) and reassurance (feelings). The healthy mind can use information to sort, organize, differentiate, and create sequences to reach a conclusion. But, the dementia sufferer gets stuck, frustrated, angry, and scared, thereby triggering to need constantly to ask for information. The information provided by the DCG gives the dementia a sense of power, control, understanding, comfort, and security.

Help is provided by the DCG verbalizing the DCG's train of thought with cheerful chatter. For example:
Dementia sufferer: “So, where are we going? Safeway!?! Oh my—I don't remember where that is!”
DCG: “No problem—I remember. We go straight down this road, then we'll turn left up there at that stop sign . . . ”

The DCG should make sure there is no emotional penalty for asking questions, which can lead to exasperation, irritation, guilt, and worry. To avoid this, the DCG uses emotional tags:

Positive intonation

Smiling while talking

Thinking out loud

Laughing

Using voice modulation

For example, rather than:

Dementia sufferer: “What's for lunch?”

DCG: “Tuna sandwiches.”

or

Dementia sufferer: “What's for lunch?”

DCG: “I've already TOLD you! We're having tuna sandwiches.”

or

Dementia sufferer: “What's for lunch?”

DCG: “Don't ask me again—I'm tired of repeating myself!”

The DSG can use positive intonation, smiling, laughing, and voice modulation to foster security in the dementia sufferer:

Dementia sufferer: “What's for lunch?”

DCG: “How about tuna sandwiches? We haven't had those in a while.”

In addition, positive gestures can be used by the DCG, such as eye contact, touch, or a wave. The DCG should think about his or her posture to establish a more open, heart-to-heart, and friendly association with the dementia sufferer.

Recognizing that emotional needs often drive a dementia sufferer's questions, the DCG should focus on feelings and respond to emotions, rather than approaching the situation analytically. Every question asked is a chance to reassure. The emotion will remain long after the question and answer are gone. The DCG should:

Verbalize with cheerful chatter

Make sure there are no penalties

Use positive emotional tags

When a dementia sufferer needs reassurance, the DCG should:

Identify the emotional need

Respond to the emotion, not the facts

To determine whether the dementia sufferer still lacks information, the DCG should look for indicators:

Worried or quizzical expression

Anxious body language

Variations in wording

Same wording used repeatedly

The DCG should respond:

Cheerfully supply the information each time

Vary answers

Provide new information each time

Reassure with positive emotional tags.

c. Morphine-Button Effect

By making it safe for a dementia sufferer to ask questions, the DCG fosters a sense of security that reduces stress in the dementia sufferer who has come to feel that less information is needed and fewer questions need to be asked, because the information is always available. This is the bonus of the “morphine button effect.”

Step 3. Making it Safe to Trust

Society treasures independence. With dementia, the sufferer must unlearn trust in self. To foster a sense of trust in the dementia sufferer, the DCG will use the following series of steps to establish that sense of trust.

a. Tips

Tips for making the dementia sufferer feel safer:

Be punctual
the dementia sufferer is losing his or her ability to read the clock
the dementia sufferer is losing ability to track passage of time
the dementia sufferer is less in control than the DCG

Provide continuity in caregivers
the dementia sufferer is becoming less able to learn new things
, the dementia sufferer is becoming more dependent and needy
the dementia sufferer needs to know the DCG will be there

Respect “Dementia Time”
the dementia sufferer is unable to focus or pay attention
the dementia sufferer is less able to identify dreams vs reality
the dementia sufferer may perseverate

b. Tools

The dementia sufferer may be unable to retain information, accomplish a task, or recall the past. The DCG should make the dementia sufferer feel that it is safe not to have information.

Tools the DCG can use to make the dementia sufferer feel safe not to have information:

Verbalize train of thought with cheerful chatter

Be happy to supply information as needed

Use emotional tags

Avoid testing memory
Learning is less and less possible
Testing memory sets the dementia sufferer up for failure
Testing memory causes anxiety, which increases forgetfulness

Make information readily available

Give information without penalty

The dementia sufferer may be unable to perform or complete tasks. The DCG should make it safe to be unable to accomplish a task.

Tools the DCG can use to make the dementia sufferer feel safe not to complete tasks:

Verbalize one step at a time:
For example:
   Dementia sufferer: “Oh no—where are my keys!?! How could I have lost them again! Oh where are they . . . !”
   DCG: “Well, let's see. Let's look in your purse first . . . I think you usually put them in that zippered compartment . . . So, not there, no problem. Next we look in the bottom of your purse . . . No? Okay, next . . . ”

Model doing the task:
For example:
   DCG: “Well, let's see now. Where is that hose? Oh here it is, now we can water the flowers. And we'll need to turn it on . . . oh, yes, there's the faucet . . . That's right, turn it the other way. Great, now we can water the flowers . . . Isn't it nice out!”

Empathize with being forgetful or unable:
For example:
   DCG: “You know, I lose my keys all the time. My husband is always reminding me to put them back in my purse.”

These tools help the dementia sufferer become comfortable not finishing tasks. In addition, the dementia sufferer becomes comfortable being led, rather than attempting, but failing, to lead.

c. Accept Dementia Sufferer's Reality

The dementia sufferer may be unable to recall the past. Generally, there are three types of memory errors:
(a) Memories may be false: “Look—there's that woman with the green hat. She's here every day!”
(b) Memories may be incorrect: “It's been years since we've come here! How come you never bring me anymore?”
(c) Memories may be lost: “So who are you?” (when a child drops in)

Tools the DCG can use to make the dementia sufferer feel safe not remembering:

Comfort in the present

Accept the dementia sufferer's reality

Step 4. Create Social Success

To foster a sense of wellbeing in the dementia sufferer, the DCG must use tools to help the dementia sufferer feel socially successful.

a. Tools

The DCG should foresee awkward moments. For example, when an old friend approaches to chat, the DCG should supply information. For example:
DCG: “Oh, we haven't met—my name's Judy, what's yours? How long have you two been friends? . . . You met at school? . . . ”
or
DCG: “I'm sorry, I've forgotten your name—I'm so bad with names . . . ”

Similarly, when transacting business, the DCG should:

Allow the dementia sufferer to attempt the task first without assistance

Engage with the cashier or shopkeeper as you would an approaching friend

Quietly say what's needed in the next blank on the check she's writing.

When beginning or ending an activity or event, the DCG should:

Chatter about what is about to happen as you approach

Chatter about what has just happened as you leave

Choose one aspect of the event to recount (i.e., the one most beneficial to mood)

The DCG should manage conversations so that the dementia sufferer “wins”. The DCG should note that the dementia sufferer can access feelings, beauty, and senses, but may not be capable of accessing facts, figures, or decisions with more than two choices. To help the dementia sufferer win, the DCG should:

Supply needed information with chatter and any facts needed

Focus on senses

Avoid future and near past

Focus on the present

Point out beauty, color, taste, texture, or music

Bring the conversation around to a favorite story, anecdote, joke, etc.

Introduce a topic that will stroke ego

Mention a story or joke the dementia sufferer loves to tell

Using these tools, the DCG can make any moment an opportunity to create a successful encounter for the dementia sufferer and avoid fear of embarrassment.

The right sensory stimulation will help the dementia sufferer succeed socially. The DCG should determine whether more or less sensory or social stimulation is need to help the dementia sufferer feel relaxed. Sensory stimulation can include walks, trips (e.g., to antique shops, art galleries, etc.), scenic drives, eating at a restaurant, attending concerts, conversation, public places, meeting people one-on-one, movies, and the like.

In fostering social success, the DCG must interact with the dementia sufferer. To promote such interaction, the DCG must look into the dementia sufferer's eyes and share the moment and focus on right now, right here.

b. Modeling Techniques for Others

In performing the steps above, the DCG can also model the techniques for others, thereby promoting more successful social interaction. To do this, the DCG should manage conversations in front of others. By demonstrating how the DCG can use analysis and supply facts, while the dementia sufferer cannot, others will observe how such techniques boost the ego of the dementia sufferer and help him or her feel like a contributor.

Tool 5: Create a Sense of Control

a. Recognizing Anosognosia

With no autonomy, the dementia sufferer experiences frustration, despondency, belligerence, and obstinacy. The dementia sufferer has problems retaining information, cannot make decisions, and exercises poor judgment. These behaviors can be categorized as “anosognosia”, common with traumatic brain injury, mental illness and dementia. Anosognosia can be a complete unawareness, or unawareness limited to one or more area of impairment. In the absence of anosognosia, most dementia sufferers will be sad, fearful and anxious about the future, recognize his or her lack of judgment and safety issues, and respond to assistance readily and with gratitude. Dementia sufferers with partial anosognosia will retain only limited information. For example, a dementia sufferer may believe she cleans her home weekly, although, in fact, it has not been cleaned in months. A dementia sufferer with full anosognosia will tend to be frustrated often, believe others are making fun of him or her, believe he or she is entirely capable of self care, and perceive offers of help as insulting.

The DCG must recognize the symptoms of anosognosia:

Obstinacy

Anger

Frustration

Poor choices

Bad judgment

b. Tools

Maximizing the dementia sufferer's sense of control minimizes adverse behaviors and requires “caregiving by stealth.” Tools for establishing caregiving by stealth include:
Introducing the DCG as a friend with similar interests
Providing the least possible assistance to protect only essential safeties
Performing tasks (e.g., cleaning, shopping, safety checks) when the dementia sufferer is out with his “friend.”

c. Tools to Give Independence

Once a DCG has established a connection with the dementia, the next step is to provide the dementia sufferer with a sense of independence and control.

One way to foster independence and control is to provide the dementia sufferer with a sense of choice. Tools a DCG can use for fostering the sense of choice include asking open-ended questions and reducing choices that require analysis. For example, the DCG can ask:
“What would you like to do today?”
“Why are you sad?”
“Where did you put your purse?”

Similarly, the DCG can make choices easier, by asking either/or questions, doing the analysis for the dementia sufferer, and recognizing that understanding brings comfort. For example, the DCG can ask:
“Would you like to walk or go in the car?
“Are you sad because you worry about me?”
“Let's look for your purse.”
   Or, the DCG can make choices visible. For example, the DCG can show clothes for dressing or a meal for eating.

The use of catchphrases can help the dementia sufferer feel more control. A catchphrase is a repeated utterance with peculiar phrasing. Catchphrases may be lyrical or alliterative, which helps the information to stick in the dementia sufferer's mind. Examples of catchphrases a DCG can use are “Maple Bar Monday”, “Beautiful blue bedroom”, or “Hug time”.

Another tool a DCG can use to foster a dementia sufferer's sense of independence and control is to make choices appear to be the dementia sufferer's idea. Examples include:
The DCG expresses what the dementia sufferer prefers
The DCG pretends to have forgotten what the dementia sufferer asked and then apologizes for having forgotten
   For example: “I'm so sorry—you asked me to remind you about your appointment this afternoon. But, we still have time to go. I'm so sorry for almost forgetting!”
The DCG tells the dementia sufferer that he or she corrected the DCG's mistake.
   For example: “Thank you so much for telling me the correct way to do this—I just never knew! You said to do it this way . . . ”

Tool 6: Create a Sense of Value

a. Listen

To foster a sense of value in the dementia sufferer, the DCG must actively listen. This is especially necessary when the dementia sufferer is speaking slowly, or when wording is odd or wrong. To listen effectively, the DCG must make eye contact, should smile and nod, allow pauses, focus on the feeling, and listen for ideas, not words.

b. Accept What is Said

To foster a feeling of value in the dementia sufferer, the DCG must accept the dementia sufferer's reality and not correct them. For example, if the dementia sufferer says:
“That Hitler, he should have been recycled.”
   The DCG should not correct the misused word. Rather, the DCG should ignore the mistake, accept the inaccuracy, and focus on the idea. Dementia takes away vocabulary and the ability to learn or re-learn, so the tool is acceptance, not accuracy.

c. Support Altered Reality

Reality comes from memories, is based on sensory data, and is personal. The dementia sufferer's loss of memory changes reality for them. When reality differs, the DCG should accept, even add to it, but avoid contradicting the altered reality. The DCG should identify the emotion driving the belief, tweak expectations with additional facts, if possible, and make the altered reality more comfortable.

d. Make it Someone Else's Fault

Dementia means often being the one at fault. To relieve the dementia sufferer from the burden of fault and guilt, the DCG should shift blame. In casting blame, the DCG should be careful to pick a generalized third party—someone distant. A family member or a specific person should not be targeted.

Examples of shifting blame include:
Getting the dementia sufferer to wash his or hands, because “strangers” leave germs in bathrooms
Getting out of the hot tub, because of “the insurance company's” rules
Taking medications, because “we don't want the doctor to worry about us”

E. Give a Chance for the Dementia Sufferer to be Gracious

The dementia sufferer makes many mistakes and the dementia sufferer and those around him or her can create an atmosphere of negative expectation that can be demoralizing. Allowing the dementia sufferer to be gracious is empowering.

The DCG can employ several tools that allow the dementia sufferer to be gracious. For example:

The DCG should be at fault for forgetting something

The DCG should need a hug

The DCG should lose something right in front of the dementia sufferer

The DCG should let the dementia sufferer pay (reimburse in secret later)

The DCG may say he or she paid last time

The DCG should thank the dementia sufferer for something

Tool 7: Creating a Sense of a Safe Future

a. Apply the Tools

The tools of the present invention help teach the dementia sufferer that the future is safe by the application of the previous tools.

Tool 1: Managing mood

Tool 2: Making it safe to ask

Tool 3: Making it safe to trust

Tool 4: Creating social success

Tool 5: Fostering a sense of control

Tool 6: Fostering a sense of value

b. Identify What Symbolizes Security

The DCG should identify a personal symbol that symbolizes the sense of security between the DCG and the dementia sufferer. For example, the DCG can discuss the dementia sufferer's:

Desire to find a spouse

Beautiful bedroom

Financial security

Coffee and paper

Pet

c. Balance Safety and Independence

The dementia sufferer requires care, but the care can be stifling. With too little security, the dementia sufferer may be placed at risk (e.g., wandering) or feel scared, but with too much the care may be smothering.

The DCG must persuade the dementia sufferer that he or she maintains some independence, but not at the expense of security. Upon departing, a DCG may say:
“Thanks so much—see you later.”
   But, this can provoke uncertainty in the dementia sufferer, who may respond:
“When will I see you next?”

A tool for providing security, but not to the extent of destroying the dementia sufferer's sense of independence is to follow the lead of the dementia sufferer. For example, at a restaurant, the DCG may foster a sense of independence by saying:
“I'll have whatever you're having.”

In this way, the dementia sufferer is allowed to take the lead.

d. Be Present as Much as Needed

Without clinging, the DCG must be present as much as needed. The DCG should listen for and be ready to respond to the dementia sufferer's needs. For example, the dementia sufferer may ask:
“I'd feel better if I could hold your arm.”
   In response, the DCG should offer support.

This need is often difficult at the transition from daytime to nighttime, when a dementia sufferer may ask:
“Would you like to stay over—I don't like to be alone.”
   To the extent possible, the DCG must be able to respond by being present as much as needed.

e. Verbalize Love and Caring

The dementia sufferer may be alone and without family support, or may feel alone as recognition of family dims. This will lead to a feeling of being unloved. The DCG should express words of love and affection to fill the dementia sufferer's need for companionship. The precise words less important than the tome and manner in which they are expressed.

The drawing and description set forth here represent only some embodiments of the invention. After considering these, skilled persons will understand that there are many ways to perform the method of dementia care according to the principles disclosed. The inventor contemplates that the use of alternative techniques, which result in a method of performing dementia care according to the principles disclosed, will be within the scope of the invention.

I claim:

1. A method for a care giver or care givers to provide care to a person suffering from dementia, comprising the steps of:
managing a mood of a person suffering from dementia by first managing a care giver's own mood by focusing the care giver's attention on the present moment, empathizing with the person's dementia and focusing attention on the person rather than a task of care;
making it safe for the person to ask questions by providing information, chattering, avoiding emotional penalties associated with asking questions, and recognizing emotional tags such as the person's intonation, modulation, expression, gestures, or posture to determine the person's security to ask questions;
making it safe for the person to trust the care giver by being punctual, and using the same care giver or care givers;
the step of making it safe for the person to trust by respecting the person's dementia, the step of respecting the person's dementia comprising the steps of providing information and reassurance to the person without emotional penalties and avoiding testing the person's memory, the step respecting the person's dementia further comprising verbalization of each actions performed by the caregiver, modeling the actions for the person, and empathizing with the person's forgetfulness, the step of empathizing with the person's forgetfulness further comprising the steps of accepting the person's false, incorrect, lost, or altered memories;
creating social success for the person by foreseeing awkward moments, managing conversations so that the person can win, supplying facts, focusing on the present and avoiding future or past events, or leading the person to favorite stories;
creating a sense of control for the person by recognizing a level of anosognosia in the person and, if the level of anosognosia is other than none, providing care by stealth to foster in the person feelings of independence, the step of providing care by stealth further comprising the steps of enabling the person to engage in choices and letting the person believe the choices were the person's,
creating a sense of value in the person by listening to the person and accepting and supporting the person's reality, the step of accepting and supporting the person's reality further comprising the step of casting blame on other people where the person has encountered problems, the step of accepting and supporting the person's reality further comprising the step of providing the person with opportunities to be gracious; and
creating a sense of wellbeing and safety in the future by identifying a symbol of security for the person and expressing feelings of care and affection for the person.

2. The method for a care giver or care givers to provide care to a person suffering from dementia of claim 1:
wherein the step of managing mood further comprises evaluating the person for signs of a present cause of the person's distress and using positive emotions, chattering, modeling behavior, or sensory or social stimulation to distract the person, while accepting the person's altered versions of reality;
the step of making it safe for the person to ask questions further comprising the step of providing reassurance when reassurance is needed by listening for feelings rather than words, and providing varying and positive responses to the person's emotions; and
the step of creating social success further comprising the step providing sensory stimulation, making eye contact, or modeling the actions for the person;
